(19) United States
(12) Patent Application Publication
(10) Pub. No.: US 2026/0083619 A1
(43) Pub. Date: Mar. 26, 2026

(54) SUCKING TYPE MASSAGER

(71) Applicants: Shenzhen Enke Innovation Technology Co., Ltd, Shenzhen (CN); Dongguan Rijie Electronic Technology Co., Ltd, Dongguan (CN)

(72) Inventors: Xinbo CAI, Shenzhen (CN); Yibiao DENG, Shenzhen (CN); Quan ZHAO, Dongguan (CN); Changbao YIN, Dongguan (CN)

(73) Assignees: Shenzhen Enke Innovation Technology Co., Ltd, Shenzhen (CN); Dongguan Rijie Electronic Technology Co., Ltd, Dongguan (CN)

(21) Appl. No.: 18/940,717

(22) Filed: Nov. 7, 2024

(30) Foreign Application Priority Data
Sep. 24, 2024 (CN) 2024113407289
Sep. 24, 2024 (CN) 2024223358335

(51) Int. Cl. A61H 9/00

(52) U.S. Cl. CPC A61H 9/0057; A61H 9/0071; A61H 2201/123

(57) ABSTRACT

The present disclosure discloses a sucking type massager, including a massage member, a piston, and a motor. The massage member includes a housing, a piston cavity, a first gas channel, and a second gas channel, where the piston cavity is disposed at one end of the housing, the first gas channel is disposed inside the housing, one end of the first gas channel is in communication with the piston cavity, at least one second gas channel is distributed on the housing at intervals, one end of the second gas channel is in communication with the first gas channel, and the other end of the second gas channel penetrates through the housing. A piston is matched with the piston cavity and is disposed in the piston cavity.

### CROSS-REFERENCE TO RELATED APPLICATIONS

The application claims priority to Chinese patent application No. 2024113407289, filed on Sep. 24, 2024, Chinese patent application No. 2024223358335, filed on Sep. 24, 2024, the entire contents of which are incorporated herein by reference.

### TECHNICAL FIELD

The present invention relates to massagers, and in particular, to a sucking type massager.

### BACKGROUND

Most existing massage apparatuses adopt mechanical beating and kneading manners, the mechanical massage manner exerts rough force, and some sensitive groups or sensitive parts of the human body are more difficult to adapt to the rough massage, and therefore, various massagers using air pressure massage have emerged. However, such air pressure massagers have a unified defect that only one air pressure port for massage is provided and the massage head is relatively small. Therefore, it is difficult for a user to experience large-area or multi-point-position massage effect at the same time, and an actual massage effect is greatly reduced. A sucking type massager is urgently needed in the market, which can realize large-area and multi-point-position massage at the same time.

### SUMMARY

The present invention provides a sucking type massager which is used for solving the problem that the sucking type massager can perform large-area and multi-point-position massage at the same time.

According to a first aspect of the present invention, a sucking type massager is provided, including:
a massage member, including a housing, a piston cavity, a first gas channel, and a second gas channel, where the piston cavity is disposed at one end of the housing, the first gas channel is disposed inside the housing, one end of the first gas channel is in communication with the piston cavity, at least one second gas channel is distributed on the housing at intervals, one end of the second gas channel is in communication with the first gas channel, and the other end of the second gas channel penetrates through the housing;
a piston matched with the piston cavity and disposed in the piston cavity; and
a motor used for driving the piston to reciprocate in the piston cavity.

Further, the housing is further provided with a buffer cavity, the buffer cavity is disposed at one end of the first gas channel away from the piston cavity, and the buffer cavity is in communication with the first gas channel.

Further, a flow guiding portion is disposed at an intersection of the buffer cavity and the second gas channel, and the flow guiding portion is used for improving flow stability of gas.

Further, one end of each second gas channel connected to an outer surface of the housing is provided with a sucking cavity, the sucking cavity is a recessed cavity, the sucking cavity is in communication with the second gas channel, and a cross sectional area of the sucking cavity is greater than a cross sectional area of the second gas channel.

Further, the sucking cavity is in smooth transition with the outer surface of the housing.

Further, the piston is provided with at least one vent hole, and the vent hole penetrates through the piston.

Further, the sucking type massager further includes a two connecting rod mechanism, the motor is a rotating electric motor, one end of the two connecting rod mechanism is movably connected to the piston, and the other end of the two connecting rod mechanism is fixedly connected to an output end of the rotating electric motor.

Further, the motor is a linear electric motor, an output end of the linear electric motor is fixedly connected to the piston, and the output end of the linear electric motor can perform a telescopic movement along an axis of the piston.

### Beneficial Effects of the Present Invention

In the present invention, in a working process of the sucking type massager, the skin of a user covers the second gas channel, and a closed space is formed among the piston cavity, the first gas channel and the second gas channel. When the motor drives the piston to move in a direction of inside of the housing in the piston cavity, the piston compresses air, and the air moves from the piston cavity to the second gas channel along the first gas channel, resulting in a greater pressure in the closed space, and the increased pressure has an upward thrust on the skin covering above the second gas channel. As the distance by which the piston moves in the direction of the inside of the housing increases, the upward thrust subjected by the skin also increases. Similarly, when the motor drives the piston to move in a direction of outside of the housing in the piston cavity, the pressure in the closed space is reduced, and the reduced pressure has an inward sucking force on the skin covering above the second gas channel. As the distance by which the piston moves in the direction of the outside of the housing increases, the inward sucking force subjected by the skin increases. As the motor drives the piston to reciprocate in the piston cavity, the skin of the user is subjected to outward pushing and the inward sucking force by the gas of the closed space at intervals. The skin of this area is sucked at intervals, so that the massage effect of sucking is realized.

In the present invention, at least two second gas channels are disposed on the housing, so that the area to be sucked can be expanded. Since there are a plurality of second gas channels, and a position where each second gas channel makes contact with the skin is a massage point position, so that multi-point-position massage is realized.

### BRIEF DESCRIPTION OF THE DRAWINGS

The accompanying drawings which constitute a part of the present invention provide further understanding of the present invention. The schematic embodiments of the present invention and description thereof are intended to explain the present invention and are not intended to constitute an improper limitation of the present invention. In the drawings:

FIG. 1 is a sectional view of a specific implementation according to the present invention;

FIG. 2 is a schematic diagram of a three-dimensional structure of a specific implementation according to the present invention;

FIG. 3 is an exploded view of a specific implementation according to the present invention;

FIG. 4 is an air flow diagram of a compressed closed space according to the present invention;

FIG. 5 is an air flow diagram of an expanded closed space according to the present invention;

FIG. 6 is a sectional view of another specific implementation according to the present invention;

FIG. 7 is a sectional view of yet another specific implementation according to the present invention;

FIG. 8 is a sectional view of still another specific implementation according to the present invention;

FIG. 9 is a schematic diagram of a three-dimensional structure of a specific embodiment with a linear electric motor according to the present invention; and

FIG. 10 is a sectional view of a specific embodiment with a linear electric motor according to the present invention.

In the figures: 1—massage member; 11—housing; 12—piston cavity; 13—first gas channel; 14—buffer cavity; 15—second gas channel; 16—sucking cavity; 17—flow guiding portion; 21—rotating electric motor; 22—linear electric motor; 3—two connecting rod mechanism; 4—piston.

### DETAILED DESCRIPTION OF THE EMBODIMENTS

It should be noted that, without conflict, the embodiments of the present application and the features in the embodiments can be combined with each other. The present invention will be described in detail below with reference to the accompanying drawings and the embodiments.

It should be noted that, unless otherwise stated, all technical and scientific terms used in the present application have same meaning as those commonly understood by those skilled in the art of the present application.

In the present invention, unless otherwise stated, the directional terms such as “upper, lower, top, and bottom” are generally used for a direction shown in the accompanying drawings, or for a component itself in a vertical, vertical, or gravity direction. Similarly, for ease of understanding and description, “inner and outer” refer to inner and outer relative to an outline of each component, but the above directional terms are not intended to limit the present invention.

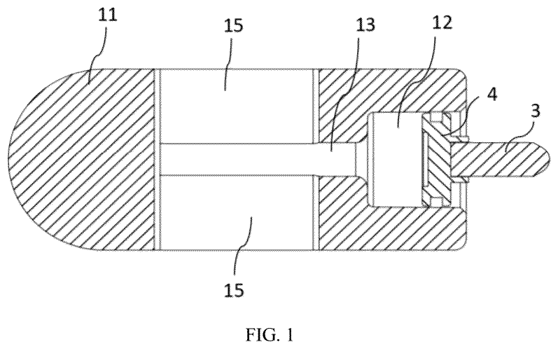

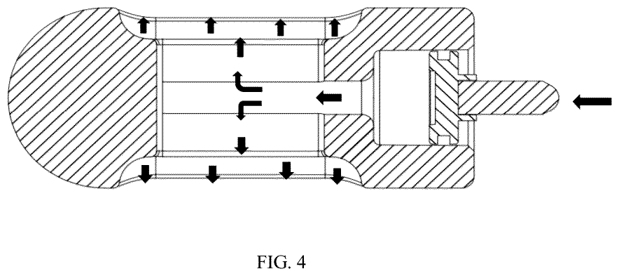

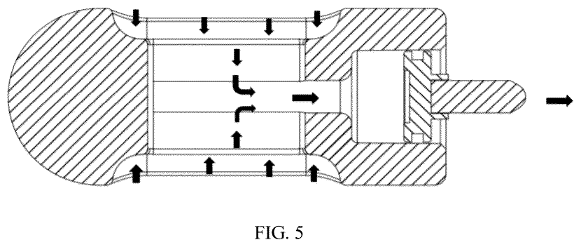

As shown in FIG. 1 to FIG. 5, according to a first aspect of the present invention, a sucking type massager is provided, including a massage member 1, a piston 4 and a motor.

The massage member 1 includes a housing 11, a piston cavity 12, a first gas channel 13, and a second gas channel 15, where the piston cavity 12 is disposed at one end of the housing 11, the first gas channel 13 is disposed inside the housing 11, one end of the first gas channel 13 is in communication with the piston cavity 12, at least one second gas channel 15 is distributed on the housing 11 at intervals, preferably there are two or more second gas channels 15, one end of the second gas channel 15 is in communication with the first gas channel 13, and the other end of the second gas channel 15 penetrates through the housing 11.

The material of the housing 11 can be selected from a hard material, or selected from a flexible material. The hard material may be metal, plastic, or a synthetic material and the like. The flexible material can be selected from rubber, silica gel, silicone rubber, polyester (PET) and the like. The selection of the flexible material can improve the tactile sensation when the skin of a user contacts the housing, thereby improving the comfort level of the user. However, the hardness of the flexible material should be appropriately high, otherwise, the housing 11 is soft, and the movement of the piston 4 in the piston cavity 12 is affected, resulting in a poor movement of the piston 4. Certainly, the flexible material and the hard material can also be used in combination. The main body of the housing 11 is made of a hard material, and then a layer of flexible material is attached to an outer face of the hard material. In this way, comfort level of contact between the housing and the human body is ensured, and rigidity of the whole housing 11 is ensured.

A piston 4 is matched with the piston cavity 12 and is disposed in the piston cavity 12.

A motor is used for driving the piston 4 to reciprocate in the piston cavity 12.

In a working process of the sucking type massager, the skin of a user covers the second gas channel 15, and a closed space is formed among the piston cavity 12, the first gas channel 13 and the second gas channel 15. When the motor drives the piston 4 to move in a direction of inside of the housing 11 in the piston cavity 12, the piston 4 compresses air, and the air moves from the piston cavity 12 to the second gas channel 15 along the first gas channel 13, resulting in a smaller volume and a larger pressure in the closed space, and the increased pressure has an upward thrust on the skin covering above the second gas channel 15. As the distance by which the piston 4 moves in the direction of the inside of the housing 11 increases, the upward thrust subjected by the skin also increases.

Similarly, when the motor drives the piston 4 to move in a direction of outside of the housing 11 in the piston cavity 12, the piston 4 drives the air to move from the second gas channel 15 to the piston cavity 12 along the first gas channel 13, resulting in a larger volume and a smaller pressure in the closed space, and the reduced pressure has an inward sucking force on the skin covering above the second gas channel 15. As the distance by which the piston 4 moves in the direction of the outside of the housing 11 increases, the inward sucking force subjected by the skin increases.

As the motor drives the piston 4 to reciprocate in the piston cavity 12, the skin of the user is subjected to outward pushing and the inward sucking force by the gas of the closed space at intervals. The skin of this area is sucked at intervals, so that the massage effect of sucking is realized.

In the present invention, at least two second gas channels 15 are disposed on the housing 11, so that the area to be sucked can be expanded. Since there are a plurality of second gas channels 15, and there are a plurality of massage point positions where the second gas channels 15 are in contact with the skin, so that multi-point-position massage is realized.

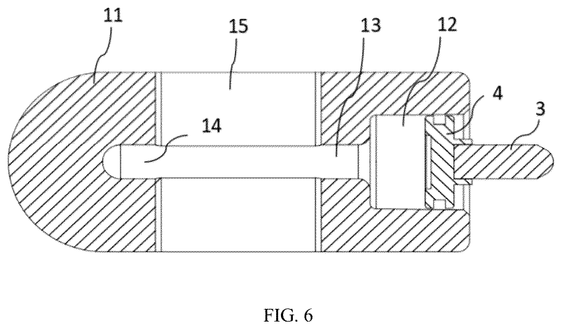

In an embodiment, as shown in FIG. 6, the housing 11 is further provided with a buffer cavity 14. Preferably, the buffer cavity 14 is disposed at one end of the first gas channel 13 away from the piston cavity 12, and the buffer cavity 14 is in communication with the first gas channel 13.

Different users can bear different massage forces, some users can bear a higher massage force, and some users can bear a lower massage force. In the above embodiment, a volume of the closed space is relatively small, the sucking force caused by the movement of the piston 4 is relatively large, and for a user who bears a relatively small massage force, a violent sucking force may make the user feel uncomfortable. The buffer cavity 14 is disposed, so that the volume of the closed space is increased. In the case that the movement stroke of the piston 4 is the same, the sucking force caused by the closed space where the buffer cavity 14 is disposed is smaller than the sucking force caused by the closed space where the buffer cavity 14 is not disposed, which is suitable for a user who bears a relatively small massage force.

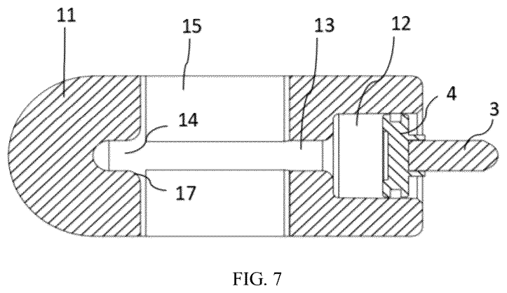

Referring to FIG. 7, as a preferred solution, a flow guiding portion 17 can be disposed at an intersection of the buffer cavity 14 and the second gas channel 15, and preferably, the flow guiding portion 17 is arc-shaped. The flow guiding portion 17 improves the flow stability of the gas, and the sucking force is evenly distributed on the massaged skin.

Certainly, a flow guiding portion 17 can also be disposed at an intersection of the first gas channel 13 and the second gas channel 15, and the principle thereof is the same, and details are not described herein again.

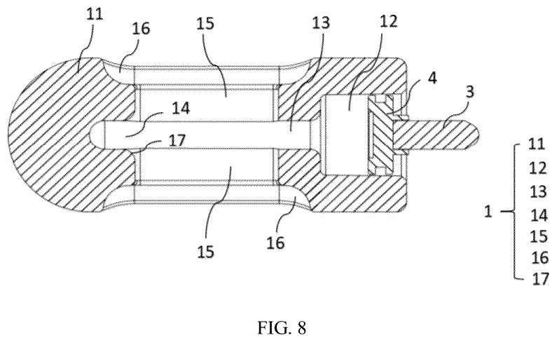

In an embodiment, as shown in FIG. 8, one end of each second gas channel 15 connected to an outer surface of the housing 11 is provided with a sucking cavity 16, the sucking cavity 16 is a cavity recessed into the housing 11, and the sucking cavity 16 is in communication with the second gas channel 15. The sucking cavity 16 can be disposed in various shapes according to the requirements of actual situations, and a cross sectional area of the sucking cavity can be greater than a cross sectional area of the second gas channel 15, and can also be less than a cross sectional area of the second gas channel 15. Preferably, the cross sectional area of the sucking cavity 16 is greater than the cross sectional area of the second gas channel 15. When the cross sectional area of the sucking cavity 16 is selected to be less than the cross sectional area of the second gas channel 15, a plurality of sucking cavities 16 are disposed, and each sucking cavity 16 is connected to one second gas channel 15, and the functions of enlarging the massage area and increasing the massage point position can also be achieved. Alternatively, one second gas channel 15 is in communication with a plurality of sucking cavities 16, the functions of enlarging the massage area and increasing the massage point position can also be achieved. There are a plurality of specific implementations, and similar designs that can achieve the same function are all within the scope of protection of the present invention.

The sucking cavity 16 is disposed, so that the volume of the closed space can be further increased, and in the working process of the sucking type massager, the sucking force is further reduced. Meanwhile, since the cross sectional area of the sucking cavity 16 is greater than that of the second gas channel 15, the contact area between the sucking type massager and the skin of the user can be further increased, and the area to be massaged is increased.

Preferably, the sucking cavity 16 is in smooth transition with the outer surface of the housing 11. When the piston 4 moves in a direction of outside of the housing 11 in the piston cavity 12, the pressure in the closed space is reduced, and the reduced pressure has an inward sucking force on the skin covering above the second gas channel 15. The skin is sucked into the sucking cavity 16, and if a joint between the sucking cavity 16 and the outer surface of the housing 11 is not in smooth transition, the skin at the position is subjected to a relatively large pressure, causing discomfort of the user. The sucking cavity 16 is in smooth transition with the outer surface of the housing 11, so that the comfort level of the user can be significantly improved.

In an embodiment, the piston 4 is provided with at least one vent hole (not shown in the figure), and the vent hole penetrates through the piston 4.

When a relatively tender part of the skin of the user is massaged, the massage force needs to be smaller, and the pressure change of the gas in the closed space needs to be smaller. A vent hole is disposed on the piston 4, so that the pressure change of the gas in the closed space can be prevented from being excessively large. When the piston 4 moves inwards, part of the gas in the closed space leaks outwards through the vent hole, so as to prevent the pressure in the closed space from increasing too fast. When the piston 4 moves outwards, external gas leaks into the closed space through the vent hole, so as to prevent the pressure in the closed space from decreasing too fast. Therefore, the vent hole can reduce the pressure change.

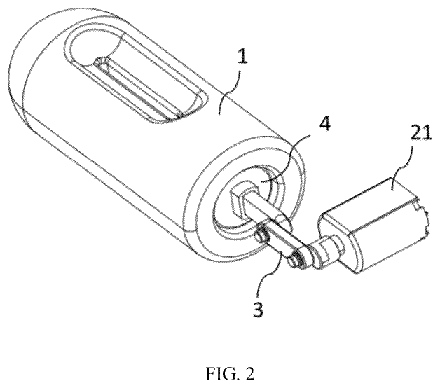

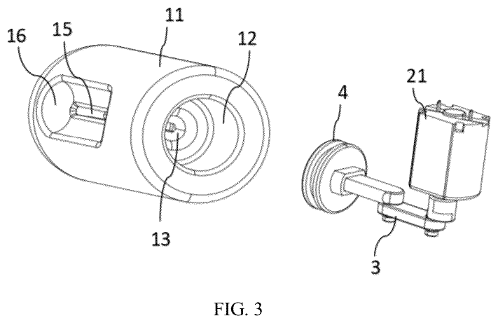

In an embodiment, as shown in FIG. 2 and FIG. 3, the sucking type massager further includes a two connecting rod mechanism 3, the motor is a rotating electric motor 21, one end of the two connecting rod mechanism 3 is movably connected to the piston 4, and the other end of the two connecting rod mechanism 3 is fixedly connected to an output end of the rotating electric motor 21.

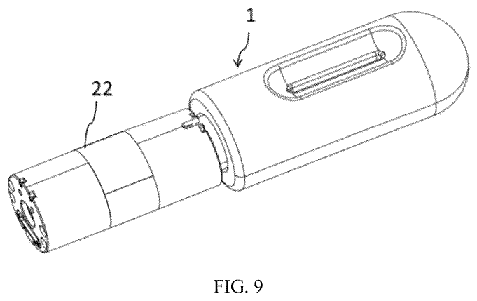

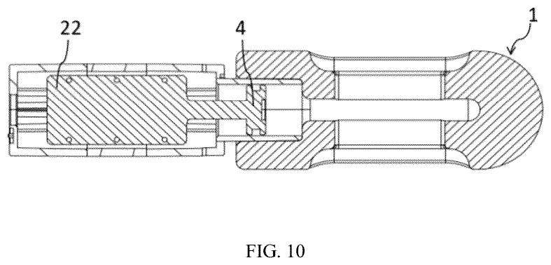

As a parallel technical solution, as shown in FIG. 9 and FIG. 10, the motor can also be a linear electric motor 22, an output end of the linear electric motor 22 is fixedly connected to the piston 4, and the output end of the linear electric motor 22 can perform a telescopic movement along an axis of the piston.

Apparently, the above embodiments described are merely a part rather than all of the embodiments of the present invention. Based on the embodiments in the present invention, all other embodiments obtained by those of ordinary skill in the art without making creative labor fall within the scope of protection of the present invention.

It should be noted that the terms used herein are only for describing the embodiments rather than for limiting the exemplary embodiments of the present application. As used herein, unless otherwise stated clearly in the context, a singular form is intended to include a plural form thereof. In addition, it should be understood that the terms “comprise” and/or “include” as used herein indicate the presence of features, steps, operations, components, assemblies, and/or combinations thereof.

It should be noted that, the terms “first”, “second”, and so on in the description and claims of the present application and in the above accompanying drawings are intended to distinguish between similar objects but do not necessarily indicate a specific order or sequence. It should be understood that the data used in this way can be interchanged where appropriate so that implementations of the present application described herein may be implemented in an order other than those illustrated or described herein.

The foregoing is merely illustrative of the preferred embodiments of the present invention and is not intended to limit the present invention, and various changes and modifications may be made by those skilled in the art. Any modifications, equivalent replacements, improvements, and the like made within the spirit and principle of the present invention shall fall within the protection scope of the present invention.

1. A sucking type massager, comprising:
a massage member, comprising a housing, a piston cavity, a first gas channel, and a plurality of second gas channels, wherein the piston cavity is disposed at one end of the housing, the first gas channel is disposed inside the housing, one end of the first gas channel is in communication with the piston cavity, the second gas channels are distributed on the housing at intervals, one end of each second gas channel is in communication with the first gas channel, and the other end of each second gas channel penetrates through the housing;
a piston matched with the piston cavity and disposed in the piston cavity; and
a motor used for driving the piston to reciprocate in the piston cavity, wherein a cross sectional area of the first gas channel is smaller than that of the piston;
wherein the housing further comprises a buffer cavity:
wherein a flow guiding portion is disposed at an intersection of the buffer cavity and the second gas channels, the flow guiding portion is arc-shaped;
wherein the piston is provided with at least one vent hole, and the vent hole penetrates through the piston.

2. (canceled)

3. The sucking type massager according to claim 1, wherein the buffer cavity is disposed at one end of the first gas channel away from the piston cavity, the buffer cavity is in communication with the first gas channel.

4. The sucking type massager according to claim 1, wherein one end of each second gas channel is connected to a sucking cavity provided on an outer surface of the housing.

5. The sucking type massager according to claim 4, wherein a cross sectional area of the sucking cavity is greater than a cross sectional area of each second gas channel.

6. The sucking type massager according to claim 4, wherein the sucking cavity is in smooth transition with the outer surface of the housing.

7. (canceled)

8. The sucking type massager according to claim 1, wherein the sucking type massager further comprises a two connecting rod mechanism, the motor is a rotating electric motor, one end of the two connecting rod mechanism is movably connected to the piston, and the other end of the two connecting rod mechanism is fixedly connected to an output end of the rotating electric motor.

9. The sucking type massager according to claim 1, wherein the motor is a linear electric motor, an output end of the linear electric motor is fixedly connected to the piston, and the output end of the linear electric motor can perform a telescopic movement along an axis of the piston.
